(19) United States
(12) Patent Application Publication
(10) Pub. No.: US 2019/0041866 A1
(43) Pub. Date: Feb. 7, 2019

(54) METHOD FOR OPERATING A MOTOR VEHICLE WITH A LIDAR SENSOR

(71) Applicant: FORD GLOBAL TECHNOLOGIES, LLC, Dearborn, MI (US)

(72) Inventors: Frederic STEFAN, Aachen (DE); Alain Marie Roger CHEVALIER, Henri-Chapelle (DE); Michael MARBAIX, Haillot (BE); Evangelos BITSANIS, Aachen (DE)

(73) Assignee: FORD GLOBAL TECHNOLOGIES, LLC, Dearborn, MI (US)

(21) Appl. No.: 16/050,646

(22) Filed: Jul. 31, 2018

(30) Foreign Application Priority Data
Aug. 1, 2017 (DE) 10 2017 213 215.9

(51) Int. Cl. G05D 1/02; G01S 7/48; G01S 17/58; G01S 17/93

(52) U.S. Cl. CPC G05D 1/0231; G01S 7/4802; H04L 67/12; G01S 17/936; G01S 17/58

(57) ABSTRACT

A method for operating a motor vehicle and a lidar sensor system mounted to a motor vehicle. A lidar sensor mounted onboard the vehicle is operated to detect an object, and to read a nano-fingerprint on the object. The nano-fingerprint may be a passive and invisible structure that can be read out with a laser scanner as a nano-barcode, a nano-QR code, or similar. A detection module extracts, from the sensor data, position data related to the object. The position data may be used to calculate a velocity and/or acceleration of a moving object, such as a second vehicle. A scanning module extracts, from the sensor data, object data encoded in the nano-fingerprint and utilizes the object data to identify the object. A control unit controls operation (such as steering, braking, etc.) of the vehicle utilizing the position data and the object data.

### CROSS-REFERENCE TO RELATED APPLICATIONS

This application claims foreign priority benefits under 35 U.S.C. § 119(a)-(d) to DE Application 10 2017 213 215.9 filed Aug. 1, 2017, which is hereby incorporated by reference in its entirety.

### TECHNICAL FIELD

The invention relates to a method for operating a motor vehicle with a lidar (laser detection and ranging) sensor, and to using the lidar sensor to read or collect data encoded on a non-fingerprint on another object, such as another vehicle. The invention also relates to an apparatus for carrying out the method.

### BACKGROUND

A self-driving vehicle (also autonomous land vehicle) denotes a passenger car or other motor vehicle, which can drive, steer and park without the intervention of a human driver (highly automated driving or autonomous driving). In the case in which no manual control by the driver is necessary at all, the term robot car is also used. In this case, the driver's seat can remain empty; the steering wheel, brake pedal and accelerator pedals may not be present.

The term “self-driving vehicle” also covers heavy goods vehicles, agricultural tractors and military vehicles without the intervention of a driver or entirely without a driver.

Self-driving motor vehicles can detect their environment by means of different sensors, and from the information obtained determine their position and that of other road users, and in cooperation with the navigation software, steer to the driving destination and avoid collisions on the route.

One type of sensors used here are so-called lidar sensors. Self-driving vehicles with lidar sensors are known, for example, from U.S. Pat. No. 9,234,618 B1.

LIDAR (abbreviation for Light/Laser Detection and Ranging) is a method for optical distance and speed measurement in a manner similar to radar. Lidar sensors use laser light instead of radio waves. Lidar sensors transmit laser pulses and detect the light reflected/scattered back to the sensor from an object. From the light propagation time of the signals, the distance to the object is calculated.

Lidar sensors have, for example, a series of laser scanners for this purpose, which may be mounted on a rotating carrier. Lidar sensors can perform 360-degree scans of their environment and detect each object or obstacle at very high speed. In general, lidar sensors provide a 3D scatter dataset, which is composed of the echoes of all objects around the motor vehicle that were struck by the lasers.

The data themselves can be used in many ways, for example for trajectory planning, detecting other road users and/or obstacle avoidance, etc. The evaluation of the data, however, consumes a great deal of computational resources, since it requires the use of very complex and costly algorithms in relation to processing power and processing time in order to be able to identify all the objects struck by the laser light and to determine the properties of the detected objects, as well as to identify or determine the manner in which the host vehicle is to react to these objects.

### SUMMARY

The object of the invention therefore is to specify a way of reducing the computing resources required.

In accordance with an embodiment of the invention, in a method for operating a motor vehicle with a lidar sensor, the following steps are performed:

exposing a nano-fingerprint disposed on an object to laser light, wherein the laser light is emitted by the lidar sensor, and wherein the nano-fingerprint is assigned to the object; reading in sensor data from the lidar sensor; and evaluation of the sensor data in order to extract object data contained in the nano-fingerprint and to assign it to the object.

The nano-fingerprint thus contains object data which make it possible to identify the type of an object detected by the lidar sensor. The nano-fingerprint can be a passive and invisible structure that can be read out with a laser scanner as a nano-barcode, a nano-QR code, or similar.

A passive nano-fingerprint of this kind may be formed at the time of production or else by applying a special layer to an object, such as a special paint finish, or by the implementation of specific chemical elements in the object, for example by laser ablation, or by means of specific patterns on the surface of the object, which are detected, for example, by laser interferometry.

Alternatively, such an active nano-fingerprint can be an active code which is stored in a memory and emitted by the nano-fingerprint when the portion of the object bearing more the nano-fingerprint is struck by a laser beam.

Such passive or active nano-fingerprints can be implemented in a wide range of objects, which can acquire relevance in transport, such as roads, road infrastructures, clothing, balls, vehicles, fences, bicycles, smartphones etc.

According to one embodiment, the object data are assigned to a meta-object.

In this case, an object is an actual physical unit which can be detected by a lidar sensor. Objects can be part of a meta-object. A meta-object in turn is any physical unit which is a composite object consisting of multiple objects.

In turn, there can be different types of meta-objects:

A transport meta-object describes a self-dependent unit consisting of at least one object. A transport meta-object can be a vehicle, such as a car, bus, lorry, tram, or a train, an item of road infrastructure, such as traffic signs, traffic lights, lamps, a fence or hedge, road, road barrier, a road user, such as a pedestrian, cyclist, or a ball.

Each transport meta-object has properties associated with it and each transport meta-object can be assigned a unique identifier.

Other information/properties can be assigned to the objects, such as the nature of the object (e.g. a door, light, wing mirror, windscreen, wheel, sphere, road, piece of material, bicycle, etc.), a material composition of the object (for example, metal, timber, asphalt, composite material, etc.) and/or the assignment of the object to a transport meta-object (such as the door of a car).

The information/properties retrieved from scanning an object can also relate to: a hoodie, a wing mirror, a wheel, a right-hand door to the meta-object of type Vehicle, a shirt or a pair of trousers from the meta-object of type Pedestrian.

According to a further feature of the embodiment, position data of the object (including velocity and/or acceleration thereof) are determined from the sensor data and assigned to the sensor data. Thus, information can be gathered by sensor data fusion, with which the environment of the motor vehicle can be reliably mapped.

The invention also relates to an apparatus and a lidar sensor, and a motor vehicle fitted with such an apparatus.

Other features, characteristics and advantages of the invention are derived from the following description of exemplary embodiments with reference to the accompanying figures.

### BRIEF DESCRIPTION OF THE DRAWINGS

FIG. 1 shows a schematic representation of an exemplary embodiment of a motor vehicle equipped with the disclosed lidar apparatus, along with an object in the form of a second motor vehicle having a nano-fingerprint; and

FIG. 2 shows components of the motor vehicle shown in FIG. 1.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

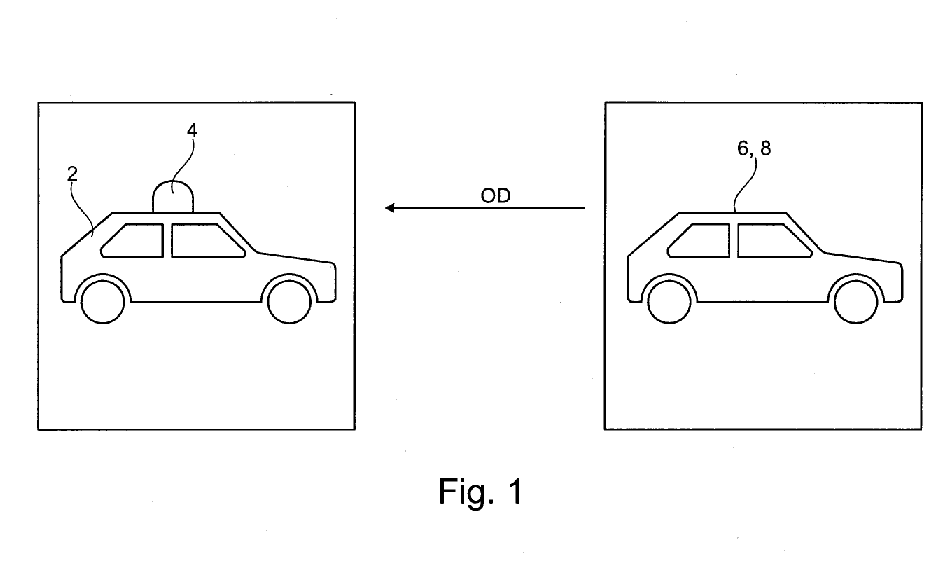

In the following, reference is first made to FIG. 1 which shows a motor vehicle 2, which may be, as in the present exemplary embodiment, a passenger car.

The motor vehicle 2 in the present exemplary embodiment is also implemented as a self-driving vehicle, which can drive, steer and park without the intervention of a human driver. In other words, the motor vehicle 2 is a Level 5 motor vehicle in accordance with the SAE J3016 classification and has the necessary components for this. By way of deviation from this exemplary embodiment, the motor vehicle 2 can be designed according to one of levels 1 to 4 in accordance with the SAE J3016 classification.

To acquire its environment and, in particular, objects 6 located in the environment, in this exemplary embodiment another road user in the form of a second moving motor vehicle, the vehicle 2 has a lidar sensor 4.

The lidar sensor 4 in the present exemplary embodiment may comprise a multiplicity of laser scanners which are mounted on a rotating carrier, thus allowing 360-degree scans of the environment of the motor vehicle 2 (as is well-known in the pertinent arts).

The output generated by the lidar sensor 4 in the present exemplary embodiment may be a 3D scatter dataset, which is composed of the echoes from all objects in the environment of the motor vehicle 2 that have been struck by laser radiation and reflected said radiation back to be received by the lidar sensor. In the present exemplary embodiment, these are the echoes of the object 6. The data of the 3D scatter dataset are used for trajectory planning, detection of other road users and/or obstacle avoidance, etc.

The actual object 6 in this exemplary embodiment has a nano-fingerprint 8 present on an exterior surface thereof at a position where the nano-fingerprint 8 may be scanned and “read” by the lidar sensor 4.

The nano-fingerprint 8 contains (in an encoded form, as is well-known in the pertinent arts) object data OD that allow properties of the object 6 detected by the lidar sensor 4 to be determined, as is explained in detail later. The nano-fingerprint 8 may be an invisible or visible structure which can be scanned or “read” with a laser scanner, such as a lidar sensor 4. The nano-fingerprint 8 may be designed as a single piece and/or from a uniform material. In addition, the nano-fingerprint 8 may be a separate component that has been connected to the object 6, or alternatively the nano-fingerprint 8 may be connected to the object 6 in a non-removable or captive fashion.

A nano-fingerprint 8 of this kind can be implemented as a passive or active component. Passive nano-fingerprints 8 can be formed at the time of production of the object 6 or alternatively by applying a special layer to the object 6, such as a special paint finish, or by the implementation of specific chemical elements in the object 6, for example by laser ablation or by means of specific patterns on a surface of the object 6, which are detected by laser interferometry, for example.

On the other hand, active nano-fingerprints 8 are operative to transmit a code stored in a memory, when the object 6 is struck by a laser beam.

In addition to the object 6 being a second motor vehicle as in the present exemplary embodiment, nano-fingerprints 8 can also be assigned to other objects, such as roads, road infrastructure items, clothing, balls, vehicles, fences, bicycles, smartphones etc.

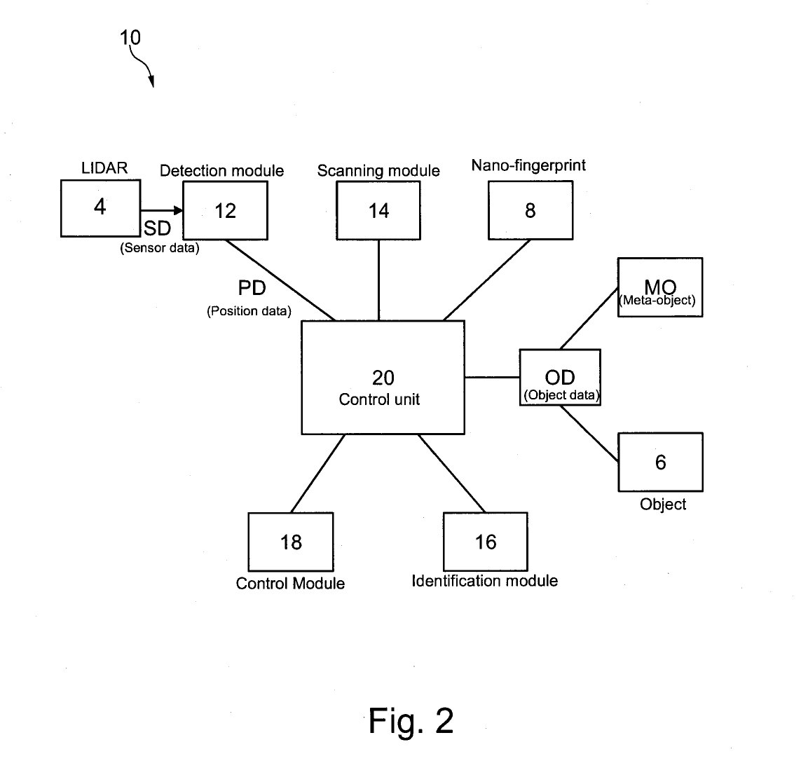

In this case, objects 6 are understood to mean each physical unit which can be detected by the lidar sensor 4. Objects 6 can be assigned to meta-objects MO (see FIG. 2). A meta-object MO in turn is any physical unit which can be a composite object consisting of a multiplicity of objects 6.

In turn, there can be different types of meta-objects MO. A transport meta-object describes a self-dependent unit consisting of at least one object 6. A transport meta-object can be a motor vehicle, such as a car, bus, lorry, tram or train, an item of road infrastructure, such as traffic signs, traffic lights, lamps, a fence or hedge, road, road barrier, a road user, such as a pedestrian, cyclist, or a ball.

Each transport meta-object has properties associated with it and each transport meta-object can be assigned a unique identifier.

Other information/properties can be assigned to the objects 6 and encoded in the nano-fingerprint 8, such as the properties of the object 6 (e.g. a door, light, wing mirror, windscreen, wheel, sphere, road, piece of material, bicycle, etc.), a material composition of the object (for example, metal, timber, asphalt, composite material, etc.) and/or the assignment of the object 6 to a transport meta-object (such as to a door of a car).

The information/properties containing object data OD that are retrieved from scanning an object 6 can also relate to: a hood, a side mirror, a wheel, a right-hand door to the meta-object of type Vehicle, a shirt or a pair of trousers from the meta-object of type Pedestrian.

By making additional reference to FIG. 2, components of apparatus 10 will now be described, which are operative to read in sensor data SD—in this exemplary embodiment a 3D scatter dataset of the lidar sensor 4—and to evaluate the sensor data SD in order to assign object data OD to the object 6, to which the fingerprint 8 is assigned.

To this end, the apparatus 10 in this exemplary embodiment has a detection module 12, a scanning module 14, an identification module 16, a control module 18 and a control unit 20.

The apparatus 10, the detection module 12, the scanning module 14, the identification module 16, the control module 18 and/or the control unit 20 can have hardware and/or software components for the tasks and functions described in the following.

The detection module 12 in operation accesses the lidar sensor 4 from which it receives the sensor data SD, extracts the object 6 from the sensor data SD, and determines the coordinates of the object 6, which are provided in the form of position data PD. In the case where the object 6 is moving, such as a second motor vehicle, rates of change in the position data are used to determine dynamic properties of the object such as velocities and accelerations thereof.

The scanning module 14 is operative to extract the object data OD contained or encoded in the nano-fingerprint 8 from the sensor data SD. The scanning module 14 therefore is able to identify the object 6 based upon the object data OD.

For the purpose of scanning or “reading” the nano-fingerprint, the lidar sensor 4 may comprise a second lidar unit which works in a special identification mode. For example, a plurality of laser beams can be grouped together in order to perform a scan of the object 6 that is struck by the lidar sensor 4 for object recognition.

Alternatively, the lidar sensor 4 can be modified in such a way that additional secondary laser beams, such as an arrangement with four laser light sources, are implemented around a primary laser beam. The secondary laser beams are operated to perform an identification scanning of the nano-fingerprint 8, while the primary laser beams are used for object recognition of the object 6.

This can be done by modifying the operation for object recognition. The apparatus can operate in two operating modes: a conventional object detection/location mode and an object identification mode.

During the conventional object detection/location mode, objects 6 are detected position data PD obtained, and then in a subsequent object identification mode a scan of these objects 6 is performed for the purpose of identification by scanning and reading the nano-fingerprint 8.

During the object identification mode, the laser beams can be grouped into sub-arrays in order to enable the scanning of objects 6.

In addition, the lidar sensor 4 can be operative to apply a laser interferometry or laser ablation technique in order to scan a specific micro-pattern of a surface of the object 6 or to determine the specific chemical composition of the object 6.

An alternating or switching frequency between the two modes can be defined in relation to the actual traffic scenario (traffic density, environment, etc.), vehicle status (speed, acceleration, etc.), or a driving maneuver (overtaking, parking, etc.).

Furthermore, the detection module 12 can be operative to carry out a handshake procedure together with the nano-fingerprint 8.

The identification module 16 is operative to associate objects 6 with meta-objects MO. The associations can be defined by analyzing membership relationships of the objects 6.

In addition, the identification module 16 is operative to determine properties of meta-objects MO. The properties can be determined by analyzing membership relationships of the objects 6.

In addition, the identification module 16 is operative to determine contours of meta-objects MO. All objects 6 which belong to the same meta-object MO are grouped by means of an algorithm. Different objects 6 at the same positions are grouped to determine the contour of the respective meta-object MO to which they belong.

In addition, the identification module 16 is operative to determine coordinates of the respective meta-objects MO. This can be done by determining, for example, an average value of all coordinates of all objects 6 of the meta-object MO.

Finally, the identification module 16 is operative to provide coordinates of meta-objects MO, limits and dimensions of meta-objects MO, and properties of meta-objects MO for the control module 18.

The control module 18 is operative to operate or control the motor vehicle 2 in accordance with Level 5 of the SAE J3016 classification.

The control module 18 is operative to determine a trajectory for the motor vehicle 2 and to operate the motor vehicle in accordance with the sensor data SD and the output data of the detection module 12. For example, the control module 18 may use meta-objects of the type “Road” in order to determine a route to follow, and/or may use meta-objects of the type “Vehicle” to determine a trajectory and a control strategy for the vehicle 2, for example to perform necessary overtaking or braking operations.

The control unit 20 is the central controller for the operation of the apparatus 10. It performs functions such as activation of the apparatus 10 and its components, activation of the lidar object recognition mode and the lidar object identification mode and their coordination, activation of an object identification and recognition mode, as well as the provision of data for the control module 18.

In operation, the detection module 12 accesses the sensor data SD, extracts the object 6 and determines the coordinates of the object 6, which are provided in the form of position data PD.

The scanning module 14 identifies the object 6 by extracting the object data OD of the nano-fingerprint 8.

The identification module 16 then assigns detected objects 6 to meta-objects MO.

The identification module 16 also determines the respective properties and contours of meta-objects MO.

In addition, the identification module 16 provides coordinates of meta-objects MO, limits and dimensions of meta-objects MO, and properties of meta-objects MO for the control module 18.

By evaluation of the sensor data SD and the output data of the detection module 12, the control module 18 determines a trajectory for the motor vehicle 2.

Thus, by using nano-fingerprints 8, object-related data such as object data OD can be provided, the acquisition and evaluation of which reduce the demand for computing resources of a motor vehicle 2, designed in particular as a self-driving motor vehicle.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for operating a motor vehicle, comprising:
operating a lidar sensor mounted onboard the vehicle to detect an object, read a nano-fingerprint on the object, and to generate sensor data;
operating a detection module to extract, from the sensor data, position data related to the object;
operating a scanning module to extract, from the sensor data, object data encoded in the nano-fingerprint and utilize the object data to identify the object; and
operating a control unit to control operation of the vehicle utilizing the position data and the object data.

2. The method of claim 1, further comprising:
operating an identification module to assign the object data to a meta-object, and wherein the control unit controls operation of the vehicle further utilizing information relating to the meta-object.

3. The method of claim 1, wherein the object is a second motor vehicle and the position data are used to determine a velocity of the second motor vehicle.

4. The method of claim 1, wherein the nano-fingerprint is passive.

5. A motor vehicle comprising:
a lidar sensor operative to transmit laser radiation, receive reflections of the laser radiation from an object, and generate sensor data therefrom; and
computer apparatus operative to: extract, from the sensor data, position data related to the object; extract, from the sensor data, object data encoded in a nano-fingerprint present on the object; utilize the object data to identify the object; and control operation of the vehicle utilizing the position data and the object data.

6. The motor vehicle of claim 5, wherein the computer apparatus is further operative to assign the object data to a meta-object, and control operation of the vehicle further utilizing information relating to the meta-object.

7. The motor vehicle of claim 5, wherein the object is a second motor vehicle and the position data are used to determine a velocity of the second motor vehicle.

8. The motor vehicle of claim 5, wherein the nano-fingerprint is passive.

9. A method comprising:
operating a lidar sensor of a motor vehicle to determine a position of an object and to scan a nano-fingerprint on the object;
operating computer apparatus to extract object data contained/encoded in the nano-fingerprint and to associate it with position data of the object; and
controlling operation of the vehicle in accordance with the position data and the object data.

10. The method of claim 9, further comprising:
operating the computer apparatus to assign the object data to a meta-object, and wherein the operation of the vehicle is controlled further utilizing information relating to the meta-object.

11. The method of claim 9, wherein the object is a second motor vehicle and the position data are used to determine a velocity of the second motor vehicle.

12. The method of claim 9, wherein the nano-fingerprint is passive.
